(19) United States
(12) Patent Application Publication
(10) Pub. No.: US 2012/0296647 A1
(43) Pub. Date: Nov. 22, 2012

(54) INFORMATION PROCESSING APPARATUS

(75) Inventors: Yuka Kobayashi, Kanagawa (JP); Tetsuro Chino, Kanagawa (JP); Kazuo Sumita, Kanagawa (JP); Hisayoshi Nagae, Kanagawa (JP); Satoshi Kamatani, Kanagawa (JP)

(73) Assignee: KABUSHIKI KAISHA TOSHIBA, Tokyo (JP)

(21) Appl. No.: 13/478,518

(22) Filed: May 23, 2012

Related U.S. Application Data
(63) Continuation of application No. PCT/JP2009/006471, filed on Nov. 30, 2009.

(51) Int. Cl. G10L 15/26

(52) U.S. Cl. 704/235; 704/E15.043

(57) ABSTRACT

In an embodiment, an information processing apparatus includes: a converting unit; a selecting unit; a dividing unit; a generating unit; and a display processing unit. The converting unit recognizes a voice input from a user into a character string. The selecting unit selects characters from the character string according to designation of the user. The dividing unit converts the selected characters into phonetic characters and divides the phonetic characters into phonetic characters of sound units. The generating unit extracts similar character candidates corresponding to each of the divided phonetic characters of the sound units, from a similar character dictionary storing a plurality of phonetic characters of sound units similar in sound as the similar character candidates in association with each other, and generates correction character candidates for the selected characters. The display processing unit makes a display unit display the generated correction character candidates selectable by the user.

### CROSS-REFERENCE TO RELATED APPLICATION

This application is a continuation of PCT international application Ser. No. PCT/JP2009/006471 filed on Nov. 30, 2009, which designates the United States; the entire contents of which are incorporated herein by reference.

### FIELD

Embodiments described herein relate generally to an information processing apparatus.

### BACKGROUND

Among information processing apparatuses which recognize linguistic information input by a voice from a user, convert the linguistic information into a character string, and display the character string, there is an information processing apparatus which enables a user to correct an erroneously converted character string by manuscript input.

The information processing apparatus stores character string candidates generated in a procedure of converting the linguistic information input from the user into the character string. In a case where the information processing apparatus converts the linguistic information into an erroneous character string and displays the erroneous character string, the user designates the character string of the erroneously converted portion. The information processing apparatus presents the user with character string candidates for the designated character string, from the stored character string candidates. The user selects one character string from the presented character string candidates. The information processing apparatus substitutes the character string of the erroneously converted and displayed portion with the selected character string.

However, in the technology mentioned above, in a case of erroneously recognizing the linguistic information input by the voice from the user, a correct character string may not be included in the stored character string candidates such that the user may not select the correct character string, and is put to inconvenience in correction.

### BRIEF DESCRIPTION OF THE DRAWINGS

FIGS. 1A and 1B are views illustrating an appearance of an information processing apparatus according to a first embodiment;

FIG. 2 is a block diagram illustrating a configuration of the information processing apparatus;

FIG. 3 is a flow chart illustrating a character-string correcting process of the information processing apparatus;

FIG. 4 is an exemplary view illustrating similar character candidates stored in a similar character dictionary;

FIG. 5 is a view illustrating similar character candidates for alphabets stored in the similar-character dictionary; and

FIGS. 6A and 6B are views illustrating an appearance of an information processing apparatus according to a second embodiment.

### DETAILED DESCRIPTION

In an embodiment, an information processing apparatus includes: a converting unit; a selecting unit; a dividing unit; a generating unit; and a display processing unit. The converting unit is configured to recognize a voice input from a user into a character string. The selecting unit is configured to select one or more characters from the character string according to designation of the user. The dividing unit is configured to convert the selected characters into phonetic characters and divides the phonetic characters into phonetic characters of sound units. The generating unit is configured to extract similar character candidates corresponding to each of the divided phonetic characters of the sound units, from a similar character dictionary storing a plurality of phonetic characters of sound units similar in sound as the similar character candidates in association with each other, and generates correction character candidates for the selected characters. The display processing unit is configured to make a display unit display the generated correction character candidates selectable by the user.

Hereinafter, embodiments will be described in detail with reference to the drawings.

In the present specification and the drawings, identical components are denoted by the same reference symbols, and will not be described in detail in some cases.

### First Embodiment

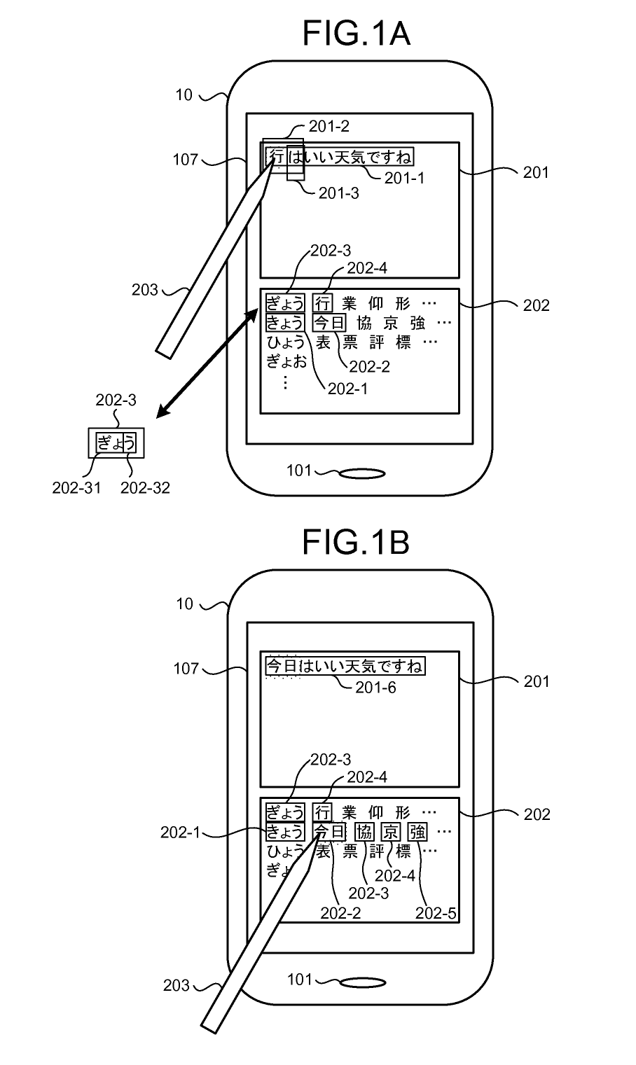

FIGS. 1A and 1B are views illustrating an appearance of an information processing apparatus 10 according to a first embodiment.

When converting a voice input from a user into a character string and display the character string, the information processing apparatus 10 can display characters unintended by the user, due to erroneous conversion. If the user designates erroneously converted characters, the information processing apparatus 10 divides the designated characters into phonetic characters which are units of sound. The information processing apparatus 10 combines similar character candidates which are similar in sound to the divided phonetic characters so as to generate correction character candidates which are correction candidates for the designated characters, and presents the correction character candidates to the user.

For example, when the user utters a character 202-1 (pronounced ‘kyou’ in Japanese) for making the information processing apparatus 10 display a character 202-2 (pronounced ‘kyou’ in Japanese), the information processing apparatus 10 may recognize a character 202-3 (pronounced ‘gyou’ in Japanese) and convert the character 202-3 into a character 202-4 (pronounced ‘gyou’ in Japanese). In this case, if the user designates the character 202-4 using a touch pen 203 or the like, the information processing apparatus 10 can present the character 202-2 (pronounced ‘kyou’ in Japanese) as a correction character candidate for the character 202-4 (pronounced ‘gyou’ in Japanese) to the user. Therefore, the user can simply correct the character 202-4 (pronounced ‘gyou’ in Japanese) to the character 202-2 (pronounced ‘kyou’ in Japanese).

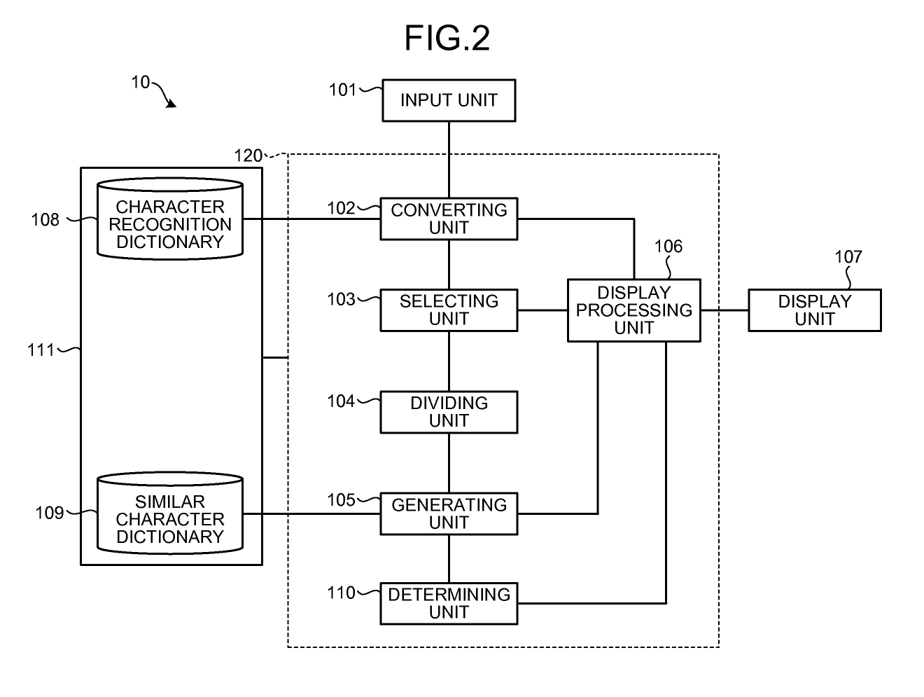

FIG. 2 is a block diagram illustrating the configuration of the information processing apparatus 10.

The information processing apparatus 10 according to the present embodiment includes an input unit 101, a display unit 107, a character recognition dictionary 108, a similar character dictionary 109, a storage unit 111, and a control unit 120. The control unit 120 includes a converting unit 102, a selecting unit 103, a dividing unit 104, a generating unit 105, a display processing unit 106, and a determining unit 110.

The input unit 101 receives the voice from the user as an input.

The converting unit 102 converts the voice input to the input unit 101 into a character string by using the character recognition dictionary 108.

The selecting unit 103 selects one or more characters from the character string obtained by the conversion of the converting unit 102, according to designation from the user.

The dividing unit 104 converts the one or more characters selected by the selecting unit 103 into phonetic characters, and divides the phonetic characters into phonetic characters of sound units. The sound units are defined as units including syllable units or phoneme units.

The generating unit 105 searches the similar character dictionary 109 storing a plurality of phonetic characters of sound units similar in sound in association with one another, and extracts similar character candidates similar in sound for each of the phonetic characters of the sound units obtained by the division of the dividing unit 104. The generating unit 105 combines the extracted similar character candidates to generate correction character candidates. The generating unit 105 may use a kanji (or, kanji character) conversion dictionary (not illustrated) to convert the correction character candidates into kanji characters, and outputs the kanji characters to the display unit 107.

The display processing unit 106 makes the display unit 107 displays the character string obtained by the conversion of the converting unit 102 such that the character string is selectable by the user. The display processing unit 106 makes the display unit 107 display the correction character candidates generated by the generating unit 105.

The display unit 107 includes not only a display section but also an input section such as a pressure-sensitive touch pad or the like. The user can use the touch pen 203 to select characters or the like displayed on the display unit.

The converting unit 102, the selecting unit 103, the dividing unit 104, the generating unit 105, and the display processing unit 106 may be implemented by a central processing unit (CPU).

The character recognition dictionary 108 and the similar character dictionary 109 may be stored in the storage unit 111, for instance.

The determining unit 110 determines one correction character candidate generated by the generating unit 105, according to designation from the user.

The control unit 120 may read and execute a program stored in the storage unit 111 or the like so as to implement the function of each unit of the information processing apparatus 10.

A result of a process performed by the control unit 120 may be stored in the storage unit 111.

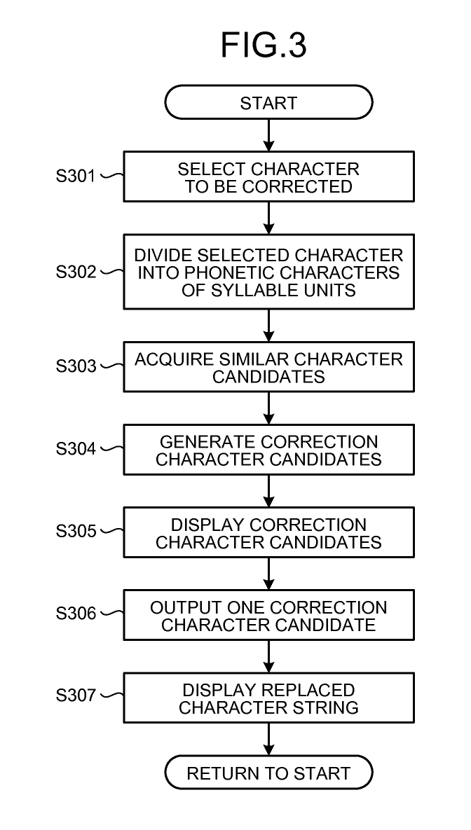

FIG. 3 is a flow chart illustrating a character string correcting process of the information processing apparatus 10.

In the character string correction of the information processing apparatus 10, the converting unit 102 converts the voice input from the user to the input unit 101, into a character string, and the display unit 107 displays the character string. In this case, if the user gives the information processing apparatus 10 an instruction to correct some characters constituting the displayed character string, the character string correction starts.

In STEP S301, the selecting unit 103 outputs one or more characters, which the user has designated from the character string obtained by the conversion of the converting unit 102, to the dividing unit 104.

In STEP S302, the dividing unit 104 divides the one or more characters selected by the selecting unit 103, into phonetic characters of sound units.

In STEP S303, the generating unit 105 extracts similar character candidates similar in sound for each phonetic character of sound units obtained by the division of the dividing unit 104, from the similar character dictionary 109.

In STEP S304, the generating unit 105 combines the extracted similar character candidates to generate correction character candidates which are correction candidates of new characters to be presented to the user.

In STEP S305, the display processing unit 106 displays the correction character candidates generated by the generating unit 105, on the display unit 107.

In STEP S306, the determining unit 110 outputs one correction character candidate designated by the user, to the display processing unit 106.

In STEP S307, the display processing unit 106 replaces the correction subject characters designated by the user and output from the selecting unit 103, with one correction character candidate output from the determining unit 110, and outputs the replaced result to the display unit 107.

According to the above-mentioned process, the user can simply correct a character string displayed by erroneous recognition.

Hereinafter, the information processing apparatus 10 will be described in detail.

In the present embodiment, a case where the information processing apparatus 10 displays an erroneous recognized character string 201-1 (pronounced ‘gyou wa ii tenki desune’ in Japanese), and the user corrects the erroneous recognized character string into a character string 201-6 (pronounced ‘kyouu wa ii tenki desune’ in Japanese) will be described.

The input unit 101 uses a microphone or the like to receive a voice as an input from the user. The input unit 101 converts (performs A/D conversion on) the voice which is an analog signal input to the microphone, into voice data which is a digital signal.

The converting unit 102 receives the voice data from the input unit 101 as an input. The character recognition dictionary 108 stores character data corresponding to the voice data. The converting unit 102 uses the character recognition dictionary 108 to converts the input voice data into a character string. In a case of conversion into a Japanese character string, the converting unit 102 may convert the voice data into a character string including not only hiragana (or hiragana character, Japanese syllabary character) but also katakana (or katakana character, Japanese another kind of syllabary character) and kanji characters.

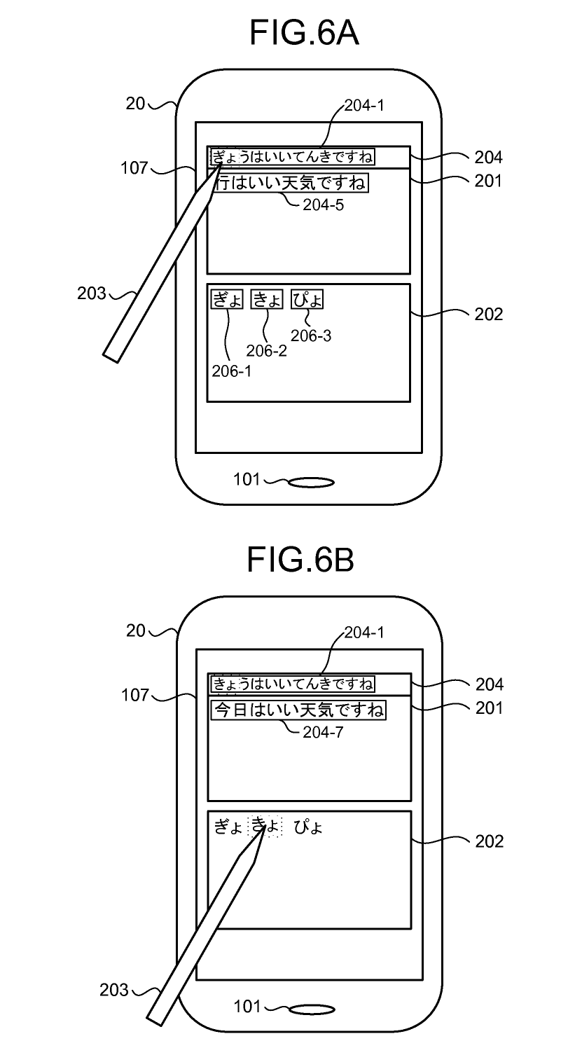

For example, the converting unit 102 receives the voice data from the input unit 101 as an input, converts the voice data into a kana (or, hiragana) character string 204-1 in FIG. 6A (pronounced ‘gyou wa ii tenki desune’ in Japanese), and further converts the kana character string into a kana-kanji character string (which is mixed with kana and kanji) 201-1 (pronounced ‘gyou wa ii tenki desune’ in Japanese). The storage unit 111 stores the kana character string and the kana-kanji character string.

The converting unit 102 outputs the converted character strings to the selecting unit 103 and the display processing unit 106.

The display processing unit 106 makes the display unit 107 display the character string obtained by the conversion of the converting unit 102, in a character string display area 201.

For example, the display processing unit 106 makes the display unit 107 display the kana-kanji character string 201-1 (pronounced ‘gyou wa ii tenki desune’ in Japanese) in the character string display area 201 as illustrated in FIG. 1A. The user designates one or more desired correction subject characters from the character string obtained by the conversion of the converting unit 102.

For example, the user uses the touch pen 203 to designate a desired correction subject character 202-4 (pronounced ‘gyou’ in Japanese) from the character string 201-1 (pronounced ‘gyou wa ii tenki desune’ in Japanese) displayed in the character string display area 201 as illustrated in FIG. 1A. The user's designation on the display unit 107 is output as a designation signal from a touch panel to the selecting unit 103 through the display processing unit 106.

The selecting unit 103 receives the designation signal, selects the character (for example, the character 202-4 (pronounced ‘gyou’ in Japanese)) which the user has designated from the character string obtained from the converting unit 102, and outputs the selected character to the dividing unit 104.

The dividing unit 104 divides the character (for example, the character 202-4) selected by the selecting unit 103, into phonetic characters of syllable units. In a case where the input character is a kanji character, the dividing unit 104 extracts phonetic characters, which represent reading of the kanji character, from the storage unit, and divides the phonetic characters into syllable units. For example, the dividing unit 104 extracts hiragana 202-3 (pronounced ‘gyou’ in Japanese) representing reading of the kanji character 202-4 (pronounced ‘gyou’ in Japanese) input from the selecting unit 103, from the storage unit 111.

In a case where a character 201-2 (pronounced ‘gyou wa’ in Japanese) is designated by the user, the dividing unit 104 converts a character 201-3 (pronounced ‘ha’ in Japanese) into a character that pronounced ‘wa’ in Japanese representing the sound of the character 201-3 (ha).

The dividing unit 104 divides the character 202-3 (gyou) into a character 202-31 (gyo) and a character 202-32 (u) which are syllable units.

The dividing unit 104 outputs the divided the character 202-31 (gyo) and the character 202-32 (u) to the generating unit 105.

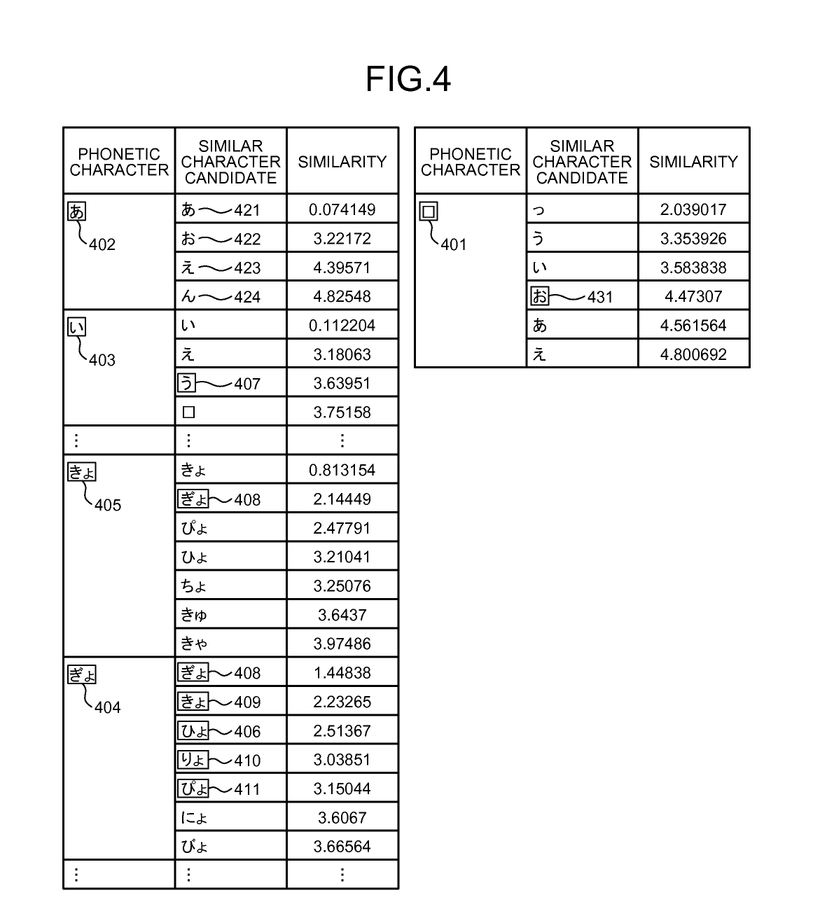

FIG. 4 is an exemplary diagram illustrating similar character candidates stored in the similar character dictionary 109.

The similar character dictionary 109 stores phonetic characters of syllable units, similar character candidates, and similarities. The character 401 of FIG. 4 will be described below.

The phonetic characters mean text data representing the sound of voice data in characters. As the phonetic characters, there are kana of Japanese, alphabets of English, Pin-yin of Chinese, Hangul characters of Korean, and the like, for example.

The similar character dictionary 109 stores one or more similar character candidates similar in sound for each phonetic character (such as a character 402 (pronounced ‘a’ in Japanese), a character 403 (pronounced ‘i’ in Japanese), and a character 404 (gyo)). For each similar character candidate, a similarity representing the degree of similarity of the sound of the similar character candidate to the sound of a basic phonetic character is determined and is stored in the similar character dictionary 109. It is preferable to determine the similarities in advance by an experiment or the like. In the similarities illustrated in FIG. 4, a smaller numerical value represents that the sound of a corresponding similar character candidate is more similar to the sound of a corresponding basic phonetic character.

For example, in FIG. 4, the similar character dictionary 109 stores similar character candidates a character 405 (gyo), a character 405 (kyo), and a character 406 (hyo) and the like for a phonetic character 404 (gyo). For each similar character candidate, in advance, the similarity is determined and stored in the similar character dictionary 109. For example, the similarity of a similar character candidate 405 (kyo) to the phonetic character 404 (gyo) is 2.23265, and the similarity of a similar character candidate 406 (hyo) to the phonetic character 404 (gyo) is 2.51367. A smaller value of the similarity defines that the sound of a corresponding similar character candidate is more similar to the sound of the phoneme 404 (gyo).

The generating unit 105 searches the similar character dictionary 109, and extracts similar character candidates for each of the character 404 (gyo) and a character 407 (u) input from the dividing unit 104. In this case, the generating unit 105 may extract similar character candidates having similarities equal to or less than a predetermined similarity.

For example, the generating unit 105 searches the similar character dictionary 109, and extracts similar character candidates 404 (gyo), 405 (kyo), and 406 (hyo) for the character 404 (gyo). In this case, the generating unit 105 is set in advance to extract similar character candidates having similarities equal to or less than 3. The similarities determining similar character candidates to be extracted may be determined in advance in an installation stage, or may be arbitrarily set by the user. In a case of extracting similar character candidates having similarities equal to or less than 3.5, the generating unit 105 extracts similar character candidates 408 (gyo), 409 (kyo), 406 (hyo), 410 (ryo), and 410 (pyo).

Even for the character 407 (u), similarly, the generating unit 105 searches the similar character dictionary 109, and extracts similar character candidates (the character 407 (u), 422 (o), 423 (e), and 424 (n) (not illustrated)).

The generating unit 105 combines the extracted similar character candidates to generate correction character candidates. For example, the generating unit 105 combines the character 407 (u), 422 (o), 423 (e), and 424 (n) with the character 404 (gyo) to generate the character 202-3 (gyou), a character that pronounced ‘gyo:’ in Japanese, a character that pronounced ‘gyoe’ in Japanese, and a character that pronounced ‘gyon’ in Japanese as correction character candidates. The generating unit 105 combines the character 407 (u), 431 (o), 423 (e), and 424 (n) with the character 409 (kyo) to generate a character that pronounced ‘kyou’ in Japanese, a character that pronounced ‘kyo:’ in Japanese, a character that pronounced ‘kyoe’ in Japanese, and a character that pronounced ‘kyon’ in Japanese as correction character candidates. Similarly, the generating unit 105 combines the remaining similar character candidates to generate correction character candidates.

In a case where there is a kanji character corresponding to a correction character candidate, the generating unit 105 may use a kanji character conversion dictionary (not illustrated) to convert the correction character candidate into the kanji character which is a correction character candidate. For example, as illustrated in FIG. 1A, the generating unit 105 converts the character 202-3 (gyou) into kanji characters to generate the character 202-2, 202-5, 202-6, 202-7 (each of which are pronounced ‘kyou’ in Japanese), and the like as correction character candidates. The generating unit 105 outputs the generated correction character candidates to the display processing unit 106 and the determining unit 110.

The display processing unit 106 outputs the correction character candidates input from the generating unit 105, to the display unit 107, such that the correction character candidates are displayed in a correction character candidate display area 202.

Also, when generating the correction character candidates, the generating unit 105 may calculate the products of the similarities of the combined similar character candidates, and output the products to the display processing unit 106. In this case, the display processing unit 106 displays the correction character candidates in the increasing order of the similarity products calculated by the generating unit 105, side by side, in the correction character candidate display area 202.

The user selects a correction character candidate displayed in the correction character candidate display area 202. For example, the user designates one correction character candidate (for example, the character 202-2 (kyou)) from the correction character candidates displayed in the correction character candidate display area 202 by using the touch pen 203 or the like. The user's designation on the display unit 107 is output as a designation signal from the touch panel to the determining unit 110 through the display processing unit 106.

The determining unit 110 receives the designation signal, and outputs the correction character candidate (for example, the character 202-2 (kyou)) designated by the user, to the display processing unit 106.

The display processing unit 106 displays the character string (for example, the character string 201-6 (pronounced ‘kyou wa ii tenki desune’ in Japanese)) obtained by replacing the desired correction subject character (for example, the character 202-4 (gyou)) of the user selected by the selecting unit 103, with the correction character candidate (for example, the character 202-2 (kyou)) designated by the determining unit 110, as a new character string, in the character string display area 201 on the display unit 107, as illustrated in FIG. 1B.

As described above, according to the present embodiment, it is possible to provide an information processing apparatus enabling a user to simply correct a character string displayed by erroneous recognition.

In the information processing apparatus 10, the user may store the corrected characters in the storage unit 111.

In a case where the user newly designates the character string including the corrected characters, the generating unit 105 searches the storage unit 111, and distinguishes characters having been already corrected one time from characters having never been corrected. For example, the storage unit 111 stores the characters having been corrected one time by the user, with raised flags. The generating unit 105 can detect the flags to distinguish the characters having been already corrected one time from the characters having never been corrected. The generating unit 105 extracts similar character candidates for the characters having never been corrected so as to generate correction character candidates.

Therefore, the information processing apparatus 10 does not need to extract similar character candidates for the characters having already been corrected, again, and thus it is possible to reduce a process cost.

Further, there are a case where the information processing apparatus 10 converts a sound, which the user has not uttered, into characters (hereinafter, referred to as a first case), and a case where the information processing apparatus 10 does not convert a sound, which the user has uttered, into characters (hereinafter, referred to as a second case).

The character 401 of FIG. 4 is a character which is silent (hereinafter, referred to as a silent character). The similar character dictionary 109 may store even the silent character 401 as a similar character candidate even for specific phonetic characters, similarly other similar character candidates. Therefore, even in the first case and the second case, the user can simply perform correction on a character string.

As an example of the first case, there may be a case in which, when the user utters “asu”, the converting unit 102 converts “asu” into “aisu”. In this case, the dividing unit 104 divides “aisu” into phonetic characters 421 (a), 403 (i), and “su” which are syllable units, according to designation from the user, and inserts the silent character 401 between the phonetic characters to generate characters that combines the character 421 (a), the silent character 401, the character 423 (i), the silent character 401, and a character that pronounced “su” in Japanese. The generating unit 105 searches the similar character dictionary 109 to extract similar character candidates for each of the character 421(a), 403(i), “su”, and 401, and generates correction character candidates.

In FIG. 4, since there is the silent character 401 in the similar character candidates for the character 403(i), the generating unit 105 can generate characters that combine the character 421 (a), the silent character 401, and a character that pronounced “su” in Japanese as a correction character candidate. The display processing unit 106 can make the display unit 107 not display the silent character 401 such that the user can designate characters that combines the character 421 (a) and a character that pronounced “su” in Japanese.

Therefore, even in the case where the information processing apparatus 10 converts a sound, which the user has not uttered, into characters, the user can simply perform correction on a character string.

As an example of the second case, there may be a case where, when the user utters “aisu”, the converting unit 102 converts “aisu” into “asu”. In this case, the dividing unit 104 divides “asu” into phonetic characters 421 (a) and “su” which are syllable units, and inserts the silent character 401 between the syllable units to generate characters that combine the character 421 (a), the silent character 401, and a character that pronounced “su” in Japanese. The generating unit 105 generates correction character candidates in the same way as that in the first case.

In FIG. 4, since there is the character 403 (i) in similar character candidates for the character 401, the generating unit 105 can generate characters (aisu) that combines the character 421 (a), the character 423 (i), and a character that pronounced “su” in Japanese as a correction character candidate.

Therefore, even in a case where the information processing apparatus 10 does not convert a sound, which the user has uttered, into characters, the user can simply perform correction on a character string.

Also, the dividing unit 104 may insert the character 401 not only between the phonetic characters, but also before the first phonetic character or after the last phonetic character. In this case, the generating unit 105 can generate more correction character candidates.

In the present embodiment, a case where the information processing apparatus 10 corrects Japanese character strings has been described. However, the embodiment is not limited only to Japanese character strings.

For example, a case of correcting an alphabet string of English will be described. Here, a case where the user corrects an alphabet string “I sink so” obtained by erroneous conversion of the information processing apparatus 10, into “I think so” will be described as an example.

The converting unit 102 converts voice data of the user input from the input unit 101 into an alphabet string (for example, “I sink so”) by using the character recognition dictionary 108. In this case, the character recognition dictionary 108 stores alphabet data corresponding to the voice data of English. The selecting unit 103 selects one or more alphabets (for example, “sink”) from the alphabet character string obtained by the conversion of the converting unit 102, according to user's designation. The dividing unit 104 divides the alphabets input from the selecting unit 103 into phoneme units (for example, “s”, “i”, “n”, and “k”).

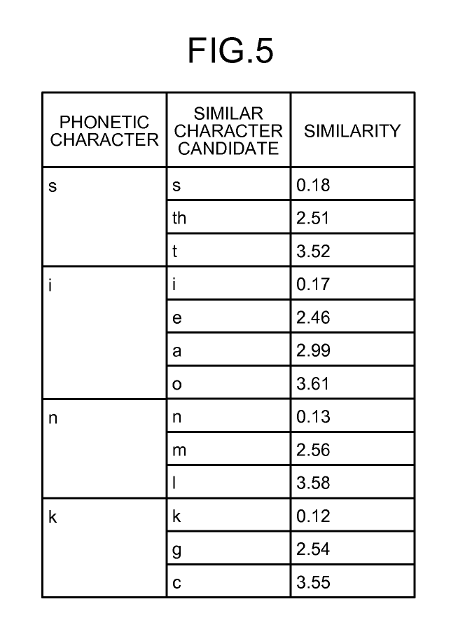

FIG. 5 is a diagram illustrating similar character candidates for alphabets stored in the similar character dictionary 109. However, in FIG. 5, only examples of “s”, “i”, “n”, and “k” are illustrated.

In a case of an alphabet string of English, characters which are apt to erroneously occur are stored as similar candidates in the similar character dictionary 109.

The generating unit 105 extracts similar character candidates (alphabets) similar in sound for each of the alphabets of the divided phoneme units from the similar character dictionary 109, in the same way as that in the case of the above-mentioned Japanese character string. The generating unit 105 combines the extracted similar character candidates to generate correction character candidates. The generating unit 105 outputs the generated correction character candidates to the display processing unit 106. In this case, it is preferable that the generating unit 105 outputs only correction character candidates existing as English words, as the combination results of the similar character candidates to the display processing unit 106.

The display processing unit 106 makes the display unit 107 display the correction character candidates.

By performing the above-mentioned process, the information processing apparatus 10 can perform not only correction on a Japanese character string but also correction on an alphabet string of English.

In a case of Chinese, it is possible to perform correction on a character string by dividing Pin-yin into sound units in the same way and by performing the process.

In a case of Korean, it is possible to perform correction on a character string by dividing Hangul characters into sound units in the same way and by performing the process.

It is possible to provide an information processing apparatus which performs the same process as that of the present embodiment on any languages having phonetic characters, other than Japanese, as described above, thereby enabling the user to simply correct a character string displayed by erroneous recognition.

Further, as long as the information processing apparatus 10 includes the control unit 120, the information processing apparatus 10 may not include the input unit 101, the display unit 107, the character recognition dictionary 108, and the similar character dictionary 109, which may be provided on the outside.

### Second Embodiment

In an information processing apparatus 20 according to the present embodiment, the display processing unit 106 displays: a kana-kanji character string including kanji characters; and a kana character string (which is formed of smaller kana placed near to kanji to indicate its pronunciation) representing reading of the kana-kanji character string on the display unit 107, such that the user can select desired correction subject characters from any one character string of the kana-kanji character string and the kana character string. Therefore, since the user can correct a character string displayed by erroneous recognition, from a kana-kanji character string and a kana character string, convenience is improved.

FIGS. 6A and 6B are diagrams illustrating the appearance of the information processing apparatus 20 according to the second embodiment.

As compared to the information processing apparatus 10 according to the first embodiment, in the information processing apparatus 20, the display processing unit 106 further displays a kana character string display area 204 on the display unit 107.

As illustrated in FIG. 6A, for example, according to an input based on user's voice, the character string 204-1 (pronounced ‘gyou wa ii tenki desune’ in Japanese) is displayed in the character string display area 201. In the kana character string display area 204, a kana character string 204-5 (pronounced ‘gyou wa ii tenki desune’ in Japanese) is displayed.

The user designates one or more desired correction subject characters from the character string displayed in the character string display area 201 by using the touch pen 203 or the like. Alternatively, the user designates one or more desired correction subject kana characters from the character string displayed in the kana character string display area 204.

Hereinafter, the information processing apparatus 20 will be described in detail. In the present embodiment, the same description as that of the first embodiment will not be made in occasion.

The converting unit 102 converts a voice input from the input unit 101 into a kana-kanji character string including kanji characters and a kana character string represented as a phonetic character string. The converted kana-kanji character string and kana character string are stored in the storage unit 111.

As illustrated in FIG. 6A, for example, the user designates desired correction subject characters 206-1 (gyo) from the kana character string 204-1 (pronounced ‘gyou wa ii tenki desune’ in Japanese) displayed in the kana character string display area 204 on the display unit 107. The selecting unit 103 selects the characters 206-1 (gyo).

The generating unit 105 receives the characters 206-1 (gyo) selected by the selecting unit 103, as an input from the converting unit 102. The generating unit 105 extracts similar character candidates (for example, the characters 206-1 (gyo), 206-2 (kyo), and 206-3 (pyo)) for the input characters 206-1 (gyo) as correction character candidates from the similar character dictionary 109 in the same way as that of the case of the first embodiment. The generating unit 105 outputs the extracted correction character candidates to the display processing unit 106.

The display processing unit 106 outputs the correction character candidates to the display unit 107 such that the correction character candidates are displayed in the correction character candidate display area 202.

The user designates one correction character candidate 206-2 from the correction character candidates displayed in the correction character candidate display area 202.

The determining unit 110 determines the correction character candidate 206-2 (kyo) designated by the user. The determining unit 110 outputs the determined correction character candidate 206-2 (kyo) to the display processing unit 106.

The display processing unit 106 replaces the kana characters 206-1 (gyo) selected by the selecting unit 103, with the correction character candidate 206-2 (kyo) determined by the determining unit 110, and outputs the corrected character string to the display unit 107 such that the corrected character string is displayed in the kana character string display area 204. The display processing unit 106 outputs an update signal to the converting unit 102.

The converting unit 102 receives the update signal from the display processing unit 106, and replaces the uncorrected kana character string stored in the storage unit 111 with the corrected kana character string. The converting unit 102 performs kanji conversion on the corrected kana character string to generate one or more kana-kanji character string candidates. The converting unit 102 may output the generated one or more kana-kanji character string candidates to the display processing unit 106. In this case, the display processing unit 106 displays the kana-kanji character string candidates on the display unit 107 (for example, the correction character candidate display area 202). If the user designates one kana-kanji character string candidate, the display processing unit 106 displays the corresponding kana-kanji character string candidate in the character string display area 201 on the display unit 107. In this way, the user can correct the character string 204-5 (pronounced ‘gyou wa ii tenki desune’ in Japanese) into the character string 204-7 (pronounced ‘kyou wa ii tenki desune’ in Japanese) as illustrated in FIG. 6B.

In the above-mentioned process, since the information processing apparatus 20 displays a kana-kanji character string and a kana character string such that the user can select any one of them, the user can simply correct a character string displayed by erroneous recognition. Further, since the user can correct a character string displayed by erroneous recognition, from a kana-kanji character string and a kana character string, conveyance is improved.

According to at least one of the present embodiments, the user can simply correct a character string displayed by erroneous recognition.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a converting unit configured to recognize a voice input from a user into a character string;
a selecting unit configured to select one or more characters from the character string according to designation of the user;
a dividing unit configured to convert the selected characters into the first phonetic characters and divides the first phonetic characters into the second phonetic characters per sound unit;
a generating unit configured to extract similar character candidates corresponding to each of the second phonetic characters, from a similar character dictionary storing a plurality of phonetic characters per sound unit being each similar in sound as the similar character candidates in association with each other, and generates correction character candidates for the selected characters; and
a display processing unit configured to make a display unit display the correction character candidates such that the correction character candidates are selectable by the user.

2. The apparatus according to claim 1, wherein
the second phonetic characters are syllable units or phoneme units, and
the generating unit extracts the similar character candidates within a predetermined similarity range for the second phonetic characters, to generate the correction character candidates.

3. The apparatus according to claim 2, wherein
the converting unit
recognizes the voice input from the user, and
converts the voice into a phonetic character string, and a kana-kanji character string obtained by performing kanji conversion on the phonetic character string, and
the selecting unit selects one or more characters from any one character string of the phonetic character string and the kana-kanji character string according to designation of the user.
